(19) United States
(12) Patent Application Publication
(10) Pub. No.: US 2014/0100872 A1
(43) Pub. Date: Apr. 10, 2014

(54) METHOD, APPARATUS, AND COMPUTER PROGRAM PRODUCT FOR SHARING PATIENT CHARTING TEMPLATES

(71) Applicant: MCKESSON FINANCIAL HOLDINGS, Hamilton (BM)

(72) Inventors: Sowmya Venugopal, Alpharetta, GA (US); Sandeep Bhardwaj, Alpharetta, GA (US)

(73) Assignee: MCKESSON FINANCIAL HOLDINGS, Hamilton (BM)

(21) Appl. No.: 13/646,207

(22) Filed: Oct. 5, 2012

(51) Int. Cl. G06Q 50/24

(52) U.S. Cl. 705/3

(57) ABSTRACT

A method for sharing patient charting templates across third party health information technology systems and practices is provided. The method may include, by a template sharing apparatus, receiving indication to share a template with another third party system, bundling template code, and transmitting notification the template is available. The third party recipient may access the template and customize the template according to the practice's needs. Corresponding apparatuses and computer program products are also provided.

### TECHNOLOGICAL FIELD

Embodiments of the present invention relate generally to computer technology and, more particularly, relate to methods, apparatuses, and computer program products for sharing patient charting templates.

### BACKGROUND

The widespread use of modern computing technology has led to an increasing demand for information to be captured and made available via computer-based applications. The medical services industry in particular relies on systems to store and maintain patient data in a centralized location made accessible to various authorized users.

Nurses, doctors, and other medical professionals may enter and access patient information in computer based applications. Decreasing the dependency on paper charts and files may allow authorized users to access patient information from different locations and may minimize the risk of losing patient records and/or creating data discrepancies, while ensuring necessary data is captured. The amount and complexity of patient information recorded during an office visit may make it difficult for a practitioner to distinguish what information is needed in certain scenarios, and what information may not need to be charted.

### BRIEF SUMMARY OF SOME EXAMPLE EMBODIMENTS

As described herein, methods, apparatuses, and computer program products for sharing EMR, or patient charting templates, are provided. In one embodiment, an originating health information technology (HIT) system may create a template to be used to update and/or retrieve information from an EMR, also referred to as a patient chart. The template may be shared with a recipient HIT system, which may be affiliated with a practice or provider different from that of the originating HIT system. The template may be compatible with the recipient HIT system so that the template may be used by the recipient practice. Furthermore, a template may be customized to better fulfill the needs of the recipient practice.

A method is provided for receiving a request to share a template with a third party system, and bundling template code including content and at least one system level variable. The bundled template code may be interpretable by the third party system. The at least one system level variable may associated with computer program instructions, and the computer program instructions may be interpretable and executable by a third party system. Execution of the computer program instructions on the third party system may result in retrieval and/or updating of at least one data record. In some embodiments, the method may include providing to the third party an option to launch the template and interpreting the bundled template code to launch the template.

According to some embodiments, the method may include receiving information identifying the third party, and transmitting a notification to the third party that the template is available to the third party. In some embodiments, the method includes receiving search criteria, searching for at least one template that satisfies the search criteria, and causing display of at least one template summary associated with the at least one template.

In some embodiments, the method may include receiving a request from the third party to customize the template, receiving an indication of at least one change to make to the template, and saving the template as a new template, including the at least one change. The method may include indicating to the third party a compensation required in order to access the template. A creator of the template may be associated with a medical practice different from a medical practice associated with the third party, and the template may comprise a patient charting template.

In some embodiments, the method may include saving the template as an original template, receiving a request to update the template to create a new version of the template, saving the new version of the template as an incremental version, and associating the incremental version with the original template. The method may include saving authorship of at least one component of the original template, and tracking the authorship in an incremental version associated with the original template.

An apparatus comprising processing circuitry is also provided. The processing circuitry may be configured to receive a request to share a template with a third party system, and bundle template code comprising content and at least one system level variable. The bundled template code may be interpretable by the third party system, and the at least one system level variable may be associated with computer program instructions. The computer program instructions may be interpretable and executable by a third party system, and execution of the computer program instructions on the third party system may result in retrieval and/or updating of at least one data record. In some embodiments, the processing circuitry may be further configured to provide the third party an option to launch the template, and interpret the bundled template code to launch the template.

According to some embodiments, the processing circuitry may be further configured to receive information identifying the third party, and transmit a notification to the third party that the template is available to the third party. In some embodiments, the processing circuitry may be further configured to receive search criteria, search for at least one template that satisfies the search criteria, and cause display of at least one template summary associated with the at least one template.

In some embodiments, the processing circuitry may be further configured to receive a request from the third party to customize the template, receive an indication of at least one change to make to the template, and save the template as a new template, including the at least one change. The processing circuitry may be further configured to indicate to the third party compensation required in order to access the template. A creator of the template may be associated with a medical practice different from a medical practice associated with the third party, and the template may comprise a patient charting template.

In some embodiments, the processing circuitry may be further configured to save the template as an original template, receive a request to update the template to create a new version of the template, save the new version of the template as an incremental version, and associate the incremental version with the original template. The processing circuitry may be further configured to save authorship of at least one component of the original template, and track the authorship in an incremental version associated with the original template.

A computer program product is also provided, including at least one non-transitory computer-readable storage medium having computer-executable program code instructions stored therein. The computer-executable program code instructions may include program code instructions to receive a request to share a template with a third party system, and bundle template code comprising content and at least one system level variable. The bundled template code may be interpretable by the third party system, and the at least one system level variable may be associated with computer program instructions. The computer program instructions may be interpretable and executable by a third party system, and execution of the computer program instructions on the third party system may result in retrieval and/or updating of at least one data record. In some embodiments, the computer-executable program code instructions may include program code instructions to provide to the third party an option to launch the template and interpret the bundled template code to launch the template.

According to some embodiments, the computer-executable program code instructions may include program code instructions to receive information identifying the third party, and transmit a notification to the third party that the template is available to the third party. In some embodiments, the computer-executable program code instructions may include program code instructions to receive search criteria, search for at least one template that satisfies the search criteria, and cause display of at least one template summary associated with the at least one template.

In some embodiments, the computer-executable program code instructions may include program code instructions to receive a request from the third party to customize the template, receive an indication of at least one change to make to the template, and save the template as a new template, including the at least one change. The computer-executable program code instructions may include program code instructions to indicate to the third party compensation required in order to access the template. A creator of the template may be associated with a medical practice different from a medical practice associated with the third party, and the template may comprise a patient charting template.

In some embodiments, computer-executable program code instructions may include program code instructions to save the template as an original template, receive a request to update the template to create a new version of the template, save the new version of the template as an incremental version, and associate the incremental version with the original template. The computer-executable program code instructions may include program code instructions to save authorship of at least one component of the original template, and track the authorship in an incremental version associated with the original template.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates third party health information technology (HIT) systems connected to a template sharing apparatus over a network according to some example embodiments;

FIG. 2 illustrates a flowchart of operations for sharing a template with another third party HIT system according to some example embodiments.

FIG. 3 illustrates a flowchart of operations for customizing a template provided by another third party HIT system according to some example embodiments.

FIG. 4 is an example display for creating or customizing a template according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to the another computing device via one or more interlinking computing devices, such as, for example, one or more servers, relays, routers, network access points, and/or the like.

FIG. 1 illustrates a system including any number of third party health information technology (HIT) systems connected to a template sharing apparatus over a network, according to some example embodiments. It will be appreciated that the system of FIG. 1 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, numerous other configurations may also be used to implement embodiments of the present invention.

The system 101 may include any number of third party health information technology (HIT) systems 110, such as 110A and 110B, that hereinafter may be referred to as system(s) 110. System(s) 110 may be configured to communicate with template sharing apparatus 102 over network 100, and may be maintained by an entity such as a pharmacy, healthcare provider, and/or insurance provider. System(s) 110 may be implemented in a variety of configurations, such as a personal computer, laptop, one or more servers, distributed system, cloud based entity, or the like, and may be accessed by individuals performing patient charting, and/or accessing or creating patient charting templates in accordance with example embodiments described herein. In some embodiments, system 110A may be associated with a separate medical practice from the medical practice associated with system 110B.

System(s) 110 may be directly coupled to template sharing apparatus 102, or may access template sharing apparatus 102 over a network 100. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet.

In some example embodiments, template sharing apparatus 102 may be embodied as or comprise one or more computing devices, such as, by way of non-limiting example, a server, configured to access network 100. In some example embodiments, template sharing apparatus 102 may be implemented as a distributed system or a cloud based entity that may be implemented within network 100. In this regard, template sharing apparatus 102 may comprise one or more servers, a server cluster, one or more network nodes, a cloud computing infrastructure, some combination thereof, or the like. Template sharing apparatus 102 may be implemented in an HIT system, similar to system(s) 110.

The template sharing apparatus 102 of FIG. 1 illustrates an example configuration according to some embodiments, such as, for example, in an embodiment in which template sharing apparatus 102 is implemented as a server. It will be appreciated that the components illustrated and described below may not be mandatory and thus some may be omitted in certain embodiments. Additionally, some embodiments may include further or different components, devices, or elements beyond those illustrated in and described with respect to FIG. 1. The template sharing apparatus 102 of one embodiment includes processing circuitry 20. Processing circuitry 20 may be configured to perform actions in accordance with one or more example embodiments disclosed herein. In this regard, the processing circuitry 20 may be configured to perform and/or control performance of one or more functionalities of the template sharing apparatus 102 in accordance with various example embodiments. The processing circuitry 20 may be configured to perform data processing, application execution, and/or other processing and management services according to one or more example embodiments. In some embodiments, the template sharing apparatus 102 or a portion(s) or component(s) thereof, such as the processing circuitry 20, may be embodied as or comprise a circuit chip. The circuit chip may constitute means for performing one or more operations for providing the functionalities described herein.

In some example embodiments, the processing circuitry 20 may include a processor 22 and, in some embodiments, such as that illustrated in FIG. 2, may further include memory 24. The processing circuitry 20 may be in communication with or otherwise control a user interface 40, and/or a communication interface 30. As such, the processing circuitry 20 may be embodied as a circuit chip (e.g., an integrated circuit chip) configured (e.g., with hardware, software, or a combination of hardware and software) to perform operations described herein.

The processor 22 may be embodied in a number of different ways. For example, the processor 22 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 22 may comprise a plurality of processors. The plurality of processors may be in operative communication with each other and may be collectively configured to perform one or more functionalities of template sharing apparatus 102 as described herein. The plurality of processors may be embodied on a single computing device or distributed across a plurality of computing devices collectively configured to function as the template sharing apparatus 102. In some example embodiments, the processor 22 may be configured to execute instructions stored in the memory 24 or otherwise accessible to the processor 22. As such, whether configured by hardware or by a combination of hardware and software, the processor 22 may represent an entity (e.g., physically embodied in circuitry—in the form of processing circuitry 20) capable of performing operations according to embodiments of the present invention while configured accordingly. Thus, for example, when the processor 22 is embodied as an ASIC, FPGA, or the like, the processor 22 may be specifically configured hardware for conducting the operations described herein. Alternatively, as another example, when the processor 22 is embodied as an executor of software instructions, the instructions may specifically configure the processor 22 to perform one or more operations described herein.

In some example embodiments, the memory 24 may include one or more non-transitory memory devices such as, for example, volatile and/or non-volatile memory that may be either fixed or removable. In this regard, the memory 24 may comprise a non-transitory computer-readable storage medium. It will be appreciated that while the memory 24 is illustrated as a single memory, the memory 24 may comprise a plurality of memories. The plurality of memories may be embodied on a single computing device or may be distributed across a plurality of computing devices collectively configured to function as the template sharing apparatus 102. The memory 24 may be configured to store information, data, applications, instructions and/or the like for enabling the template sharing apparatus 102 to carry out various functions in accordance with one or more example embodiments. For example, the memory 24 may be configured to buffer input data for processing by the processor 22. Additionally or alternatively, the memory 24 may be configured to store instructions for execution by the processor 22. As yet another alternative, the memory 24 may include one or more databases that may store a variety of files, contents, or data sets. Among the contents of the memory 24, applications may be stored for execution by the processor 22 to carry out the functionality associated with each respective application. In some cases, the memory 24 may be in communication with one or more of the processor 22, user interface 40, or communication interface 30, for passing information among components of template sharing apparatus 102.

The user interface 40 may be in communication with the processing circuitry 20 to receive an indication of a user input at the user interface 40 and/or to provide an audible, visual, mechanical, or other output to the user. As such, the user interface 40 may include, for example, a keyboard, a mouse, a joystick, a display, a touch screen display, a microphone, a speaker, and/or other input/output mechanisms. In some example embodiments in which the template sharing apparatus 102 is embodied as a server, cloud computing system, or the like, aspects of user interface 40 may be limited or the user interface 40 may not be present. Accordingly, the user interface 40 may provide input and output means to facilitate template sharing operations in accordance with one or more example embodiments.

The communication interface 30 may include one or more interface mechanisms for enabling communication with other devices and/or networks. In some cases, the communication interface 30 may be any means such as a device or circuitry embodied in either hardware, or a combination of hardware and software that is configured to receive and/or transmit data from/to a network and/or any other device or module in communication with the processing circuitry 20. By way of example, the communication interface 30 may be configured to enable template sharing apparatus 102 to communicate with system(s) 110. Accordingly, the communication interface 30 may, for example, include supporting hardware and/or software for enabling communications via cable, digital subscriber line (DSL), universal serial bus (USB), Ethernet, or other methods.

FIGS. 2 and 3 are flowcharts of operations according to some embodiments. Operations illustrated in FIGS. 2 and 3 may be performed by a template sharing apparatus 102 and, more particularly, may be performed by, with the assistance of and/or under the control of one or more of the processing circuitry 20, processor 22, memory 24, user interface 40, and/or communication interface 30.

Referring to FIG. 2, operation 200, the template sharing apparatus 102, such as the processing circuitry 20, the processor 22 or the like, may receive a request to share a patient charting template generated in association with an originating system (e.g., system 110A) with another system (e.g., system 110B, referred to as the “recipient system”), which may be associated with a different medical practice than that of the originating system 110A. In some embodiments, the request may include more than one recipient system, but for simplicity, example embodiments described herein will refer to one recipient system 110B. In one embodiment, in which the template sharing apparatus 102 is implemented in or in association with the originating system, the request may be initiated by a first user that may work for or otherwise be associated with a medical practice associated with the originating system 110A, and may be provided via user interface 40, for example. Alternatively, where the template sharing apparatus 102 is implemented, for example as a server, separate from the originating system 110A, the request to share a template may be communicated via network 100 and communication interface 30 to template sharing apparatus 102.

The request may include any information to identify the recipient system 110B, such as an email address, user id, or the like. The template may comprise any template that may be used in the patient charting context, such as, for example, a template used for scheduling a particular type of appointment and/or documenting a particular type of visit or procedure (e.g., scheduling or charting an annual physical for men over age 60, or an office visit for a patient showing flu symptoms). While the foregoing describes embodiments of the present invention as sharing and customizing templates used in the patient charting context, as one of ordinary skill in the art will recognize in light of this disclosure, embodiments of the invention are not limited to this particular environment or application. In contrast, embodiments of the present invention may likely be used to share and customize templates that could be used by any computer application to gather specific information needed for a particular scenario.

A template may comprise computer program code (referred to hereinafter as “template code”) configured to generate a template that is compatible with an application, such as a patient charting application, running on or otherwise accessible to both the originating 110A and the recipient systems 110B. In one embodiment, the template code may comprise elements, such as content and/or system level variable(s), that define what should be included within the template, how the template should be displayed and/or how the template should operate.

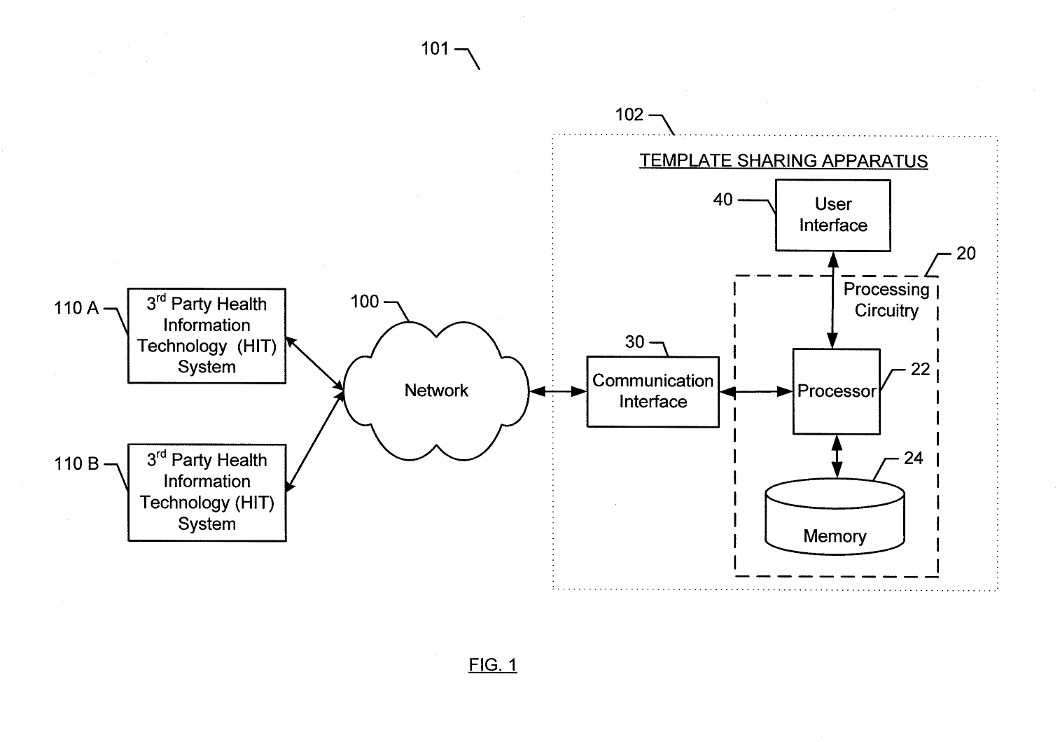

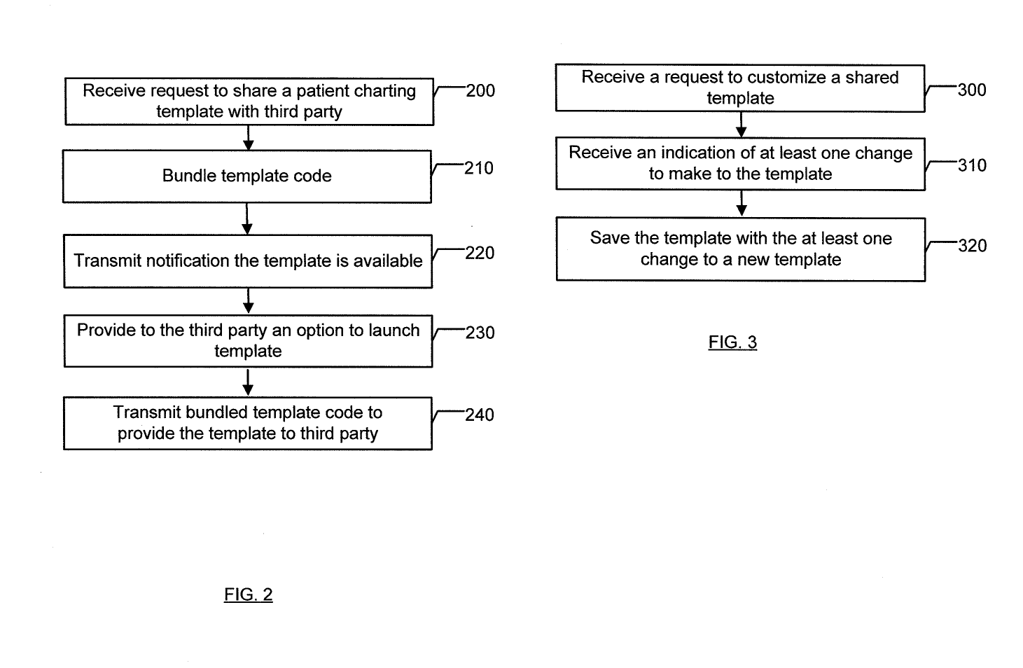

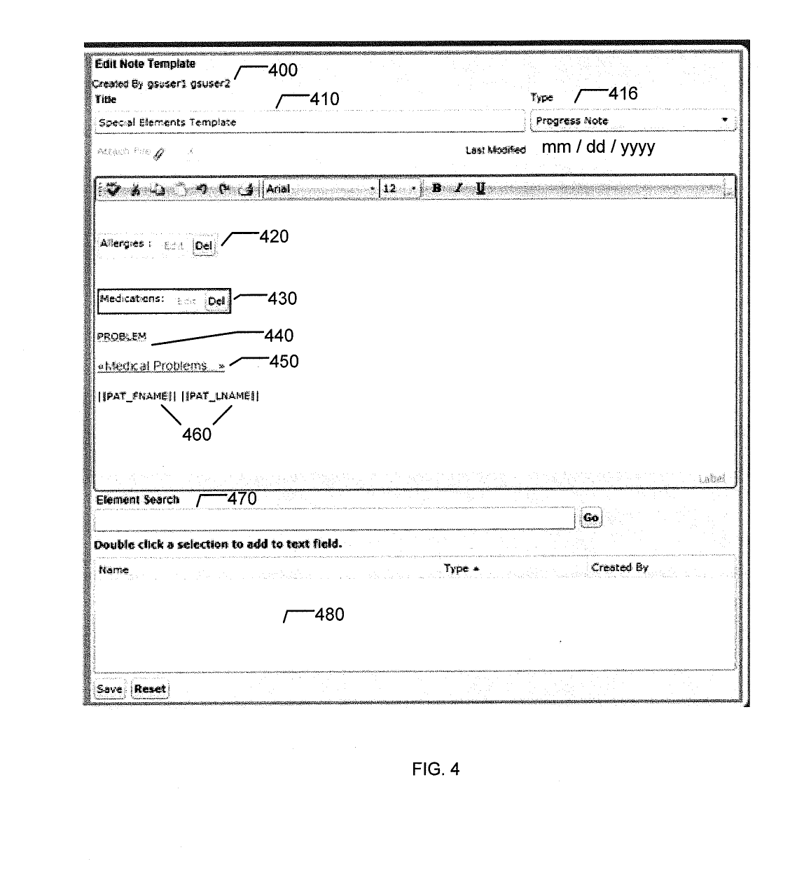

In this regard, the content may include any information such as text, images or the like that are to be included or displayed in the template. Specific, non-limiting, examples of content that may be included, such as quick text and/or pick lists, are discussed in further detail below with regard to FIG. 4.

In contrast, a system level variable may be any unique data reference, code, or the like, that may be recognized and interpreted by the recipient system 110B as providing an instruction to take some action in association with the template. In particular, according to one embodiment, upon execution of template code comprising a particular system level variable, the executing system may first access a look up or reference table comprising a mapping of system level variables to local (or system-specific) variables and/or computer program instructions that define one or more action(s) to be taken in association with each system level variable. The executing system may then execute the corresponding instructions in order to take the one or more action(s) associated with the system level variable included within the template code. As described in more detail below with regard to FIG. 4, example actions may include retrieving a specific data element from memory, displaying a retrieved data element, displaying a parameter and corresponding data field to be populated by a user with a result value associated with that parameter, and/or posting an input result value to a specific memory location.

As a further example, any of systems 110 may have access to a value for a patient age in an EMR, but due to varying system and/or database architectures, the patient age may be stored in different locations depending on the system. Accordingly, the template code may not include specific instructions for retrieving the patient's age for display in association with the template. Instead, the template code may include a system level variable, such as PATIENT_AGE, which may be recognized by a recipient system 110B (e.g., by accessing a system level variable lookup table) as providing an instruction to retrieve the patient age from the correct data table. In other words, a system level variable may comprise a placeholder for system-specific computer program code configured to perform a common action(s). Based on the foregoing, the recipient system 110B may be capable of utilizing bundled template code to access a dynamic template including content created by the originating system 110A, intertwined with system level variables compatible with and interpreted by the recipient system 110B.

In addition to the foregoing, in some embodiments, the template code may further comprise a layout defined by the originating system 110A that will define the location and order of the various components of the template when accessed by system 110B, as well as a an associated title, such as “Physical Male 60+,” so that various users can easily identify templates to be used in specific scenarios.

Returning to FIG. 2, at operations 210, the template sharing apparatus 102, or in particular, processing circuitry 20, processor 22 or the like, may bundle the template code, for example including the content, system level variables and/or layout designation associated with the template, and store the bundled template code to memory 24 in association with a unique identifier, such as a template identifier.

According to operation 220, the template sharing apparatus 102, such as the processing circuitry 20, the processor 22, the communication interface 30 or the like, may transmit a notification to the recipient system 110B indicating that the template is available. The notification may be sent to an individual or group of individuals associated with the recipient system 110B. Template sharing apparatus 102 may transmit the notification by email or secure message system, via communication interface 30 and network 100, for example, to the recipient system 110B. In some embodiments, when logging into an application, a user of the recipient system 110B may see a notification that the template is available. Additionally or alternatively, a user of the recipient system 110B may search for available templates based on keywords, recommended data fields, or other search criteria. Template sharing apparatus 102 may receive the search criteria, by communication interface 30, or the like, and run the search, with processing circuitry 20, against templates that are available to the requesting system (e.g., system 110B). Template sharing apparatus 102, by communication interface 30, or the like, may cause the display of available template summaries to the third party, including pertinent information such as a template title, type and/or description and any other information that may be used to distinguish or describe a template. A template summary may provide a high-level overview of how the template could be used. Furthermore, a template summary may be selected and viewed, as described with respect to operations 230 and 240 so that a user may decide if the template will be useful in his/her practice.

At operation 230, an option to launch the template may be provided to the recipient system 100B by the template sharing apparatus 102, such as the processing circuitry 20, the processor 22, the communication interface 30 or the like. A link may be provided in the same communication notifying the recipient system of the template, for example. Additionally or alternatively, an option to launch the template may otherwise be provided to the recipient system 110B while accessing an application providing patient charting or similar functions to a user of the recipient system 110B. In some embodiments, a user of the recipient system 110B may be prompted to provide compensation to the practice associated with the originating system 110A in exchange for using the template created by the practice associated with the originating system 110A. In this regard, medical practices may sell their templates to other practices.

At operation 240, in response to a practitioner or any user of the recipient system 110B opting to launch the template, template sharing apparatus 102, such as the processing circuitry 20, the processor 22 or the like, may access the bundled template code on memory 24, for example, and cause transmission of the bundled template code to the recipient system 110B, for example, via communication interface 30 and network 100. Additionally or alternatively, a template sharing apparatus 102 may launch the template by accessing the bundled template code and opening the template within an application running on template sharing apparatus 102, by use of processing circuitry 20. As such, the template may be provided to the recipient system 110B via use of the application over network 100 and communication interface 30. The shared template may be compatible with recipient system 110 B, such that system level variables may be interpreted and/or retrieved by system 110B. The content and layout provided by the originating system 110A may be intertwined with data retrieved from system 110B to provide a dynamic template. Additionally or alternatively, a patient context provided by system 110B, may be applied to the template so that the system level variables, when interpreted by system 110B, are associated with a particular patient record, or EMR recognized by system 110B.

Upon accessing the shared template on system 110B, a practitioner or user of the recipient system 110B may access the template for one-off scenarios or appointments which the associated practice may be unaccustomed to providing. The template provided may include informational content, such as policies and procedures, to guide a practitioner through an appointment, and provide recommended data fields to capture information in scenarios the practitioner may lack experience or the knowledge to identify as needed. The template may provide the practitioner quicker and/or cheaper methods of locating the information and procedures, as opposed to alternative solutions such as researching specialized cases online and in books, or referring patients to specialists. Templates may be used to access patient charting data associated with a patient, and/or to update or store new data on memory 24, or a memory device within or accessed by system(s) 110.

Additionally, in some embodiments, a practitioner may find a particular shared template useful, but may want to make changes to the template and customize the template for more effective or efficient use within his/her own practice. As such, the operations of FIG. 3 allow template sharing apparatus 102 to provide template customization capabilities to users of shared templates.

At operation 300, template sharing apparatus 102, such as the processing circuitry 20, the processor 22 or the like, may receive a request from a user of a system 110B, via communication interface 30, or user interface 40, for example, to customize a shared template. In response, template sharing apparatus may provide the template to the user of the system 110, in a similar way as described with respect to operation 230 and/or 240. The template may be presented to the user in such a way as to allow the user to edit, or customize the template. For example, content may be modified to better suit the needs and policies of the practice. Data fields not included in the template may be added, and/or extraneous data fields may be removed. A request for customization may result in the template sharing apparatus 102 saving the template as an original template, and saving a new version as an incremental version. In some embodiments, the same system 110 may create an incremental version of an original template, or in some embodiments, a different system, such as recipient system 110B, for example, may create an incremental version of an original template created by originating system 110A, for example. Additionally or alternatively, authorship of components of the template, such as content, may be tracked along with the incremental versions. As such, an incrementally versioned template created by recipient system 110B, created from an original template by originating system 110A, may allow a system 110 to indicate the authorship, such as an a system 110 or an associated medical practice, of components displayed in a template. The authorship may then be tracked in subsequent incremental versions.

At operation 310, template sharing apparatus 102, such as the processing circuitry 20, the processor 22 or the like, may receive, such as via network 100 and communication interface 30 or user interface 40, an indication of at least one change to make to the template. In response, at operation 320, template sharing apparatus 102, such as the processing circuitry 20, the processor 22 or the like, may save the changes to the template as a new template to memory 24. Saving the template may comprise bundling and saving a new instance of the template code, separate from the original template. Additionally or alternatively, the new template may be saved as a new version of the original template, with stored versioning information tracking the differences to the new template relative to the original template, and providing template sharing apparatus 102 the ability to reproduce the new template based on the original bundled template code and versioning information.

Upon creating a new customized template from an original shared template, a user such as a user of a system 110 may access the new template for future use, and/or share the new template with another system such as any system(s) 110, as described with regard to the operations of FIG. 2.

FIG. 4 is a display for creating or customizing a template according to some example embodiments. Indicator 400 displays the creator of the shared template which may be, for example, an individual, department, or the name of a practice associated with the originating system 110. Input 410 provides an input for a title of the template. In this example scenario, input 410 may display the name of the original template, and changing the title may result in a new template being created, such as in regard to the customization described with respect to operations 300-320. Indicator 416 may provide for selection of a template type. Options for a template type may be stored at memory 24, and may indicate to a potential user a general use or category for the template, such as a progress note, or specialty template, for example.

Continuing on, a smart code, such as smart code 420, is an example system level variable that may be included in the bundled template code. The smart code may be interpreted by system 110B, by accessing associated computer program code in a smart code lookup table, for example. Upon executing or interpreting the associated computer program code, system 110B may display a resulting smart code component on the template. As such, system 110B may provide, for example, computer program instructions, such as Structured Queried Language (SQL) associated with the smart code component, such that when a user of system 110B selects or enters data using the smart code component, system 110B may cause the computer program instructions to be executed, along with a parameter(s) corresponding to the entered data. In particular, a user of system 110B may enter or select patient information in the smart code component, such as a drug allergy. As such, including a smart code in the template may prompt a practitioner to ask questions or perform particular tests on a patient in order to collect and enter the correct data. Subsequently, the data entered in the smart code component may be stored with the patient charting information within the patient's EMR (the patient being identified by the patient context, for example), so that it may be made available to anyone accessing the patient's EMR. Using the example display of FIG. 4, a practitioner may enter a newly identified allergy. System 110B may reference the computer program instructions associated with the smart code component, and the associated EMR may be updated to include the allergy. The data may be stored on system(s) 100, or memory 24, for example.

Insert codes, such as insert code 430, may also be included in the bundled template code, as a system level variable, for example. The insert code (system level variable) may be interpreted by system 110B, by accessing associated computer program code in an insert code lookup table, for example. For example, the associated computer program code may include SQL to retrieve a patient record. The computer program code may be specific to system 110B, and may result in the retrieval of data fields known by, but potentially retrieved via different methods, by any of system(s) 110. Upon executing or interpreting the associated computer program code, system 110B may perform a set of instructions or processes, such as retrieving data from the patient's EMR, such as medications used by a patient. A resulting insert code component may be displayed on the template, populated with the retrieved data. As such, a practitioner may see medications already prescribed to a patient and may use the information in treating the patient or prescribing additional medication. Information populated by an insert code may be retrieved from recipient system 110B, or memory 24, for example.

Quick text, such as quick text 440, may be included in the bundled template code as content, for example, and may include a short content chunk representative of a long content chunk, for example. Quick text may appear as a selectable link (a short content chunk), which upon selection may display informational content (a long content chunk) to the user of the template. Quick text may be practical in situations where large bodies of content apply to the template, but would otherwise take up a substantial amount of space on a display. Using quick text, the user of the template may show or hide the content. Details useful to the practitioner during an appointment may be included in the quick text, for quick and easy access to policies and procedures or other vital information without navigating away from the application. Such information may be retrieved from system(s) 110, or memory 24, for example.

Pick lists, such as pick list 450, are another example of content that may be included in the bundled template code. A pick list may include various content chunks, providing for selection of predefined options provided by the originating system 110A. Recipient system 110B may recognize a pick list and produce a pick list component comprising the various selectable options, for example. Once the pick list component is presented on a template, a user of recipient system 110B may select one or more options. For example, the pick list component may present various medical problems, and a practitioner may select those that apply to a patient in order to store the medical problems with the patient's EMR. Additionally or alternatively, medical problems already associated with the patient, such as those retrieved from the patient's EMR, may be pre-populated in the pick list 450. The data may be accessed and/or stored on system(s) 110 or template sharing apparatus 102.

Letter codes, such as letter codes 460, for example, may be included in the bundled template code as system level variables and may be associated with data fields available to system(s) 110. Recipient system 110B may include means, such as a letter code lookup table, for identifying the appropriate data table to access the data values represented by the letter codes. In this example, PAT_FNAME and PAT_LNAME may be replaced by the patient first name and patient last name of record, respectively, when the template is accessed. The data may be retrieved from system(s) 110 or memory 24.

Having now described example content and system level variables, it will be appreciated that any components of a template, such as smart code, insert code, quick texts, pick lists, or letter codes, may be embedded inside one another.

Continuing on, search field 470 may be used by a creator of a template, or a user customizing an existing template, to search for elements to add to the template. Template sharing apparatus 102 may run the search against any components or elements available to include in a template, and display results in a search results area such as area 480. A user may select an element from area 480 to include in the template.

The display of FIG. 4 may be accessed via a system, such as system 110A, and used to create or customize a template. The elements described with respect to items 400-460 may be included in the bundled template code, as described with respect to operation 210, in order to share a template with another system, such as system 110B. The template elements illustrated in and described with respect to FIG. 4 are example elements included in a template. It will be appreciated that any other types or numbers of elements may be included in a patient charting template that may be used by a third party HIT system.

FIGS. 2 and 3 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 24) storing instructions executable by a processor in the computing device (for example, by the processor 22). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a template sharing apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a template sharing apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a request to share a template with a third party system; and
bundling, with a processor, template code comprising content and at least one system level variable, wherein the bundled template code is interpretable by the third party system.

2. A method according to claim 1, wherein the at least one system level variable is associated with computer program instructions, wherein the computer program instructions are interpretable and executable by a third party system, and wherein execution of the computer program instructions on the third party system results in at least one of a retrieval or update of at least one data record.

3. A method according to claim 1, further comprising:
providing to the third party an option to launch the template; and
interpreting the bundled template code to launch the template.

4. A method according to claim 1, further comprising:
receiving information identifying the third party; and
transmitting a notification to the third party that the template is available to the third party.

5. A method according to claim 1, further comprising:
receiving search criteria;
searching for at least one template that satisfies the search criteria; and
causing display of at least one template summary associated with the at least one template.

6. A method according to claim 1, further comprising:
receiving a request from the third party to customize the template;
receiving an indication of at least one change to make to the template; and
saving the template as a new template, including the at least one change.

7. A method according to claim 1, further comprising:
indicating to the third party a compensation required in order to access the template.

8. A method according to claim 1, wherein a creator of the template is associated with a medical practice different from a medical practice associated with the third party.

9. A method according to claim 1, wherein the template comprises a patient charting template.

10. A method according to claim 1, further comprising:
saving the template as an original template;
receiving a request to update the template to create a new version of the template;
saving the new version of the template as an incremental version; and
associating the incremental version with the original template.

11. A method according to claim 10, further comprising:
saving authorship of at least one component of the original template; and
tracking the authorship in an incremental version associated with the original template.

12. An apparatus comprising processing circuitry configured to:
receive a request to share a template with a third party system; and
bundle template code comprising content and at least one system level variable, wherein the bundled template code is interpretable by the third party system.

13. An apparatus according to claim 12, wherein the at least one system level variable is associated with computer program instructions, wherein the computer program instructions are interpretable and executable by a third party system, and wherein execution of the computer program instructions on the third party system results in at least one of a retrieval or update of at least one data record.

14. An apparatus according to claim 12, wherein the processing circuitry is further configured to:
provide to the third party an option to launch the template; and
interpret the bundled template code to launch the template.

15. An apparatus according to claim 12, wherein the processing circuitry is further configured to:
receive information identifying the third party; and
transmit a notification to the third party that the template is available to the third party.

16. An apparatus according to claim 12, wherein the processing circuitry is further configured to:
receive search criteria;
search for at least one template that satisfies the search criteria; and
cause display of at least one template summary associated with the at least one template.

17. An apparatus according to claim 12, wherein the processing circuitry is further configured to:
receive a request from the third party to customize the template;
receive an indication of at least one change to make to the template; and
save the template as a new template, including the at least one change.

18. An apparatus according to claim 12, wherein the processing circuitry is further configured to:
indicate to the third party a compensation required in order to access the template.

19. An apparatus according to claim 12, wherein a creator of the template is associated with a medical practice different from a medical practice associated with the third party.

20. An apparatus according to claim 12, wherein the template comprises a patient charting template.

21. An apparatus according to claim 12, wherein the processing circuitry is further configured to:
save the template as an original template;
receive a request to update the template to create a new version of the template;
save the new version of the template as an incremental version; and
associate the incremental version with the original template.

22. An apparatus according to claim 21, wherein the processing circuitry is further configured to:
save authorship of at least one component of the original template; and
track the authorship in an incremental version associated with the original template.

23. A computer program product comprising at least one non-transitory computer-readable storage medium having computer-executable program code instructions stored therein, the computer-executable program code instructions comprising program code instructions to:
receive a request to share a template with a third party system; and
bundle template code comprising content and at least one system level variable, wherein the bundled template code is interpretable by the third party system.

24. A computer program product according to claim 23, wherein the at least one system level variable is associated with computer program instructions, wherein the computer program instructions are interpretable and executable by a third party system, and wherein execution of the computer program instructions on the third party system results in at least one of a retrieval or update of at least one data record.

25. A computer program product according to claim 23, wherein the computer-executable program code instructions further comprise program code instructions to:
provide to the third party an option to launch the template; and
interpret the bundled template code to launch the template.

26. A computer program product according to claim 23, wherein the computer-executable program code instructions further comprise program code instructions to:
receive information identifying the third party; and
transmit a notification to the third party that the template is available to the third party.

27. A computer program product according to claim 23, wherein the computer-executable program code instructions further comprise program code instructions to:
receive search criteria;
search for at least one template that satisfies the search criteria; and
cause display of at least one template summary associated with the at least one template.

28. A computer program product according to claim 23, wherein the computer-executable program code instructions further comprise program code instructions to:
receive a request from the third party to customize the template;
receive an indication of at least one change to make to the template; and
save the template as a new template, including the at least one change.

29. A computer program product according to claim 23, wherein the computer-executable program code instructions further comprise program code instructions to:
indicate to the third party a compensation required in order to access the template.

30. A computer program product according to claim 23, wherein a creator of the template is associated with a medical practice different from a medical practice associated with the third party.

31. A computer program product according to claim 23, wherein the template comprises a patient charting template.

32. A computer program product according to claim 23, wherein the computer-executable program code instructions further comprise program code instructions to:
save the template as an original template;
receive a request to update the template to create a new version of the template;
save the new version of the template as an incremental version; and
associate the incremental version with the original template.

33. A computer program product according to claim 32, wherein the computer-executable program code instructions further comprise program code instructions to:
save authorship of at least one component of the original template; and
track the authorship in an incremental version associated with the original template.
